(19) United States
(12) Patent Application Publication
(10) Pub. No.: US 2010/0185527 A1
(43) Pub. Date: Jul. 22, 2010

(54) ON-LINE SHOPPING SYSTEM

(76) Inventor: Chien-Chung CHUNG, Taipei City (TW)

Correspondence Address: PATTERSON & SHERIDAN, L.L.P., 3040 POST OAK BOULEVARD, SUITE 1500, HOUSTON, TX, 77056, US

(21) Appl. No.: 12/356,039

(22) Filed: Jan. 19, 2009

(51) Int. Cl. G06Q 30/00

(52) U.S. Cl. 705/27

(57) ABSTRACT

The present invention sets forth a method for implementing an on-line shopping system that is capable of enhancing a consumer's on-line shopping experience. In one embodiment, the method includes steps of preparing a consumer profile comprising a first consumer information, generating a consumer image on the basis of the first consumer information, and presenting a first set of selectable items according to the first consumer information.

### BACKGROUND OF THE INVENTION

1. Field of the Invention

The present invention relates to e-commerce, and more particularly, to an on-line shopping system that is capable of enhancing consumer shopping experience.

2. Description of the Related Art

Unless otherwise indicated herein, the approaches described in this section are not prior art to the claims in this application and are not admitted to be prior art by inclusion in this section.

As the Internet and/or the World Wide Web become more and more accessible and accepted, consumers begin shopping on-line. Even so, when it comes to consumer on-line shopping experience there are still a lot to be desired. For example, the existing websites may only present consumers with all items they have chosen without taking into account whether they are suitable to them. Though consumers could manually enter or select their desired sizes for the items, they cannot visualize how they will look like with the selected items. Additionally, in the traditional shopping website setting, consumers have no opportunity to see whether their current selections match with their previous selections or whether certain combinations of the current and the previous selections are what they prefer. Moreover, as sizes for items vary from country to country (e.g., shoe size 10 for men in U.S. corresponds to shoe size 28 for men in Japan), consumers might be forced to memorize or look up the size conversions.

What is needed in the art is thus an on-line shopping system for enhancing consumer on-line shopping experience and addressing at least the foregoing issues.

### SUMMARY OF THE INVENTION

One embodiment of an on-line shopping system is disclosed. The embodiment describes a method, which includes steps of preparing a consumer profile comprising a first consumer information, generating a consumer image on the basis of the first consumer information, and presenting a first set of selectable items according to the first consumer information.

At least one advantage of the present invention disclosed herein is to provide an image according to personalized information and to allow visualization of how selected items are likely to appear.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a schematic diagram illustrating an on-line shopping system having a server and couple of consumer terminals;

FIG. 2 is a flow chart illustrating a consumer information collection process according to one embodiment of the present invention;

FIG. 3 is a flow chart illustrating an operational process according to one embodiment of the present invention; and

FIG. 4 is a schematic diagram showing an example of an interface displaying a personalized 3-D model according to one embodiment of the present invention.

### DETAILED DESCRIPTION

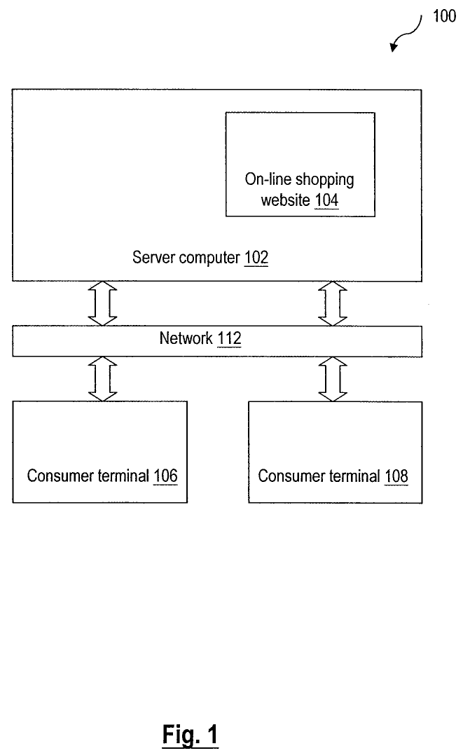

FIG. 1 is a schematic diagram showing an on-line shopping system 100, according to one embodiment of the present invention. The on-line shopping system 100 including a server computer 102 configured to provide an on-line shopping website 104 and a couple of consumer terminals 106 and 108. The consumer terminals 106 and 108 connect to the server computer 102 through a network 112. It is well understood that any number of consumer terminals might be in connection with the server computer 102 (or the website 104) through the network 112. Consumers might log onto the website 104 from the consumer terminals 106 and 108. The website 104 is configured to offer a variety of items for the consumers from the consumer terminals 106 and 108 to review and purchase. Each of the consumer terminals 106 and 108 can be, without limitation, desktops, laptops, mobile phones, personal digital assistants (PDA), etc.

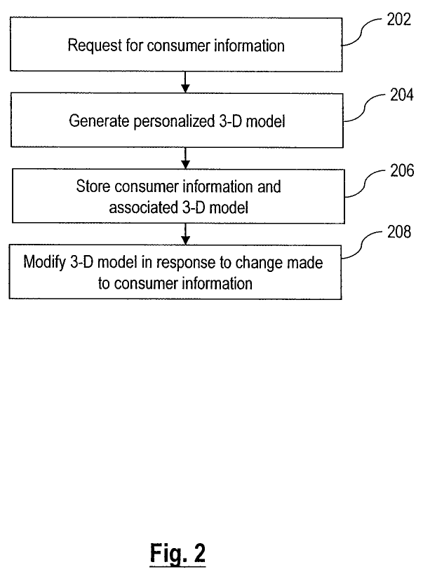

In conjunction with FIG. 1, FIG. 2 is a flow chart illustrating an operational process performed by the server computer 102 where the website 104 is running for collection of consumer information, according to one embodiment of the present invention. In step 202, the website 104 is configured to ask for inputs of certain personalized information from a consumer. Some examples of the consumer information may include, without limitation, a consumer's body measurement information such as height, weight, sizes of waist and/or shoes, length of arms and legs, and/or shoulder width. The consumer information may also include the consumer's username, password, and personal information such as shipping address and even the credit card numbers. In one implementation, the consumer information collection is performed by the server computer 102 during a registration process of the website 104. The registration process generally refers to a process during which the server computer 102 could receive consumer information from the consumer after initially asking for such inputs. It is worth noting that the computer server 102 could also receive the updates or modifications to the consumer information after the registration process. In one implementation, the consumer information could be updated or modified by the registered consumer every time after his/her log-on. The computer server 102 stores the received consumer information to a consumer profile. In step 204, in response the computer server 102 generates a personalized three-dimensional (3-D) model associated with the registered consumer according to the consumer information, such as the consumer's body measurement information.

The computer server 102 stores a predetermined 3-D image with a default set of body measurement information. At the time of generating the 3-D model for the consumer, the computer server 102 loads and adjusts the predetermined 3-D model according to the consumer's body measurement information. The entire consumer's body measurement information may comprise multiple inputs. In one implementation, the computer server 102 dynamically adjusts the predetermined image with every single input of the consumer's body measurement information from the same consumer. In another implementation, the computer server 102 adjusts the predetermined 3-D model after the entire consumer's body measurement information from the same consumer is received.

In step 206, the computer server 102 is configured to store the consumer information and the associated 3-D model to its memory space. In step 208, the computer server 102 modifies the 3-D model accordingly in response to any changes made to the consumer information, and stores the 3-D model of the latest version after the modification.

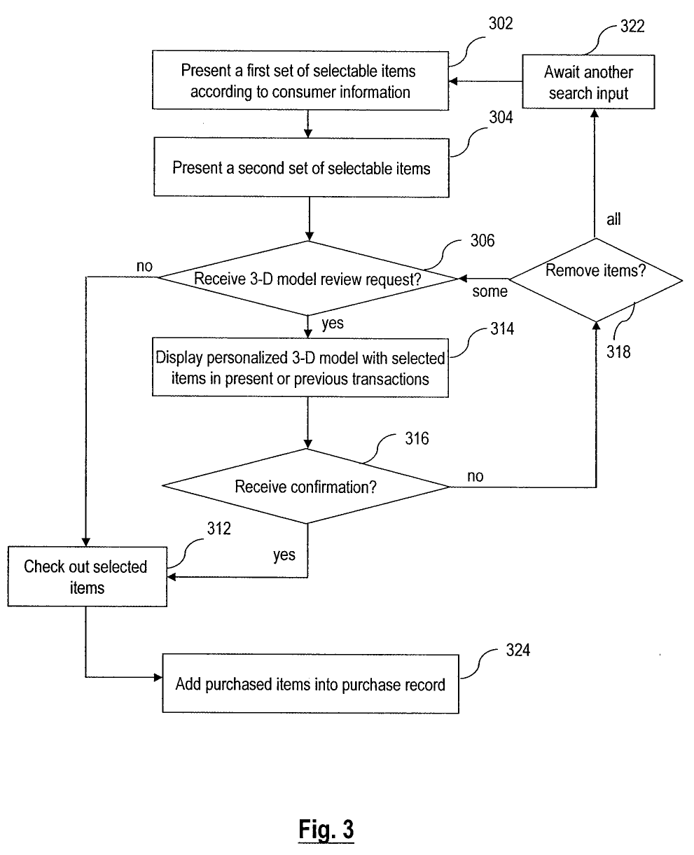

In conjunction with FIG. 1, FIG. 3 is a flow chart illustrating another operational process performed by the computer server 102 for the website 104 according to one embodiment of the present invention. At the time of logging onto the website 104, the consumer may search for items he/she targets in traditional ways. The consumer could enter the keywords for the items he/she targets or start with selecting the categories to which the target items may belong. In step 302, the website 104 presents a first set of selectable items in response to the consumer's search requests. The first set of the selectable items is picked from all the items offered by the website 104, based on the consumer's body measurement information that was entered by the consumer. For example, if the consumer intends to purchase a pair of running shoes and the consumer information stored in the consumer profile indicates that his shoe size is US 10 the website 104 may only present the items comprising the running shoes that are US 10 and its equivalent in size to the consumer. In other words, the computer server 102 proactively selects the first set of the items that is fit to the consumer's body measurement so that the website 104 could present them to the consumer. As such, the consumer no longer needs to memorize or to do the size conversion of his/her body measurement information over the course of shopping.

In step 304, at the consumer's request the website 104 may simply display another set of the selectable items. In one implementation, the second set of the selectable items may comprise all the items offered by the website 104. In another implementation, the second set of the selectable items comprises the items fit to body measurement of people other than the registered consumer, considering the registered consumer may want to do the shopping for someone else. Thereafter, the consumer might select items from either one or both sets of the selectable items. After the selection, the website 104 offers the consumer with an opportunity to try on the selected items. In step 306, the computer server 102 determines if any request for the display of the 3-D model has been received. If no request for the display is received, the website 104 checks out the items in step 312. If any request for the display is received by the server computer 102, in step 314 the website 104 displays the consumer's personalized 3-D model with the items selected. The website 104 may alarm the consumer that the items selected are not fit to the stored consumer body measurement information. The display of the personalized 3-D model with the items selected further helps the consumer determine whether the combinations of the items selected are what he/she likes. In step 314, the website 104 may also display the items that the same consumer purchased before with the items he/she selected in the present transaction on the 3-D model.

In step 316, the computer server 102 awaits the confirmation from the consumer. If the consumer likes the combination after reviewing the 3-D model, the process proceeds to step 312 allowing the website 104 to check out of the items. Otherwise, the process returns to step 318 where the website 104 asks the consumer to determine the items he/she dislikes before the computer server 102 could remove them from the consideration of the consumer. If the consumer decides to remove certain but not all items, the process proceeds to step 306 in which the computer server 102 has to determine if there is another request for the display of the 3-D model without the items the consumer dislikes. In the case that the consumer dislikes all items he/she selected earlier, the process goes to step 322 where the computer server 102 awaits another consumer searching input. Upon the receipt of another consumer searching input, the computer server 102 proceeds to step 302. Furthermore, the computer server 102 adds the items purchased in this transaction as part of a consumer purchase history to the consumer profile in step 324 after the website 104 checks out the items in step 312. It is worth noting that the consumer purchase history could also be another part of the consumer information stored in the consumer profile.

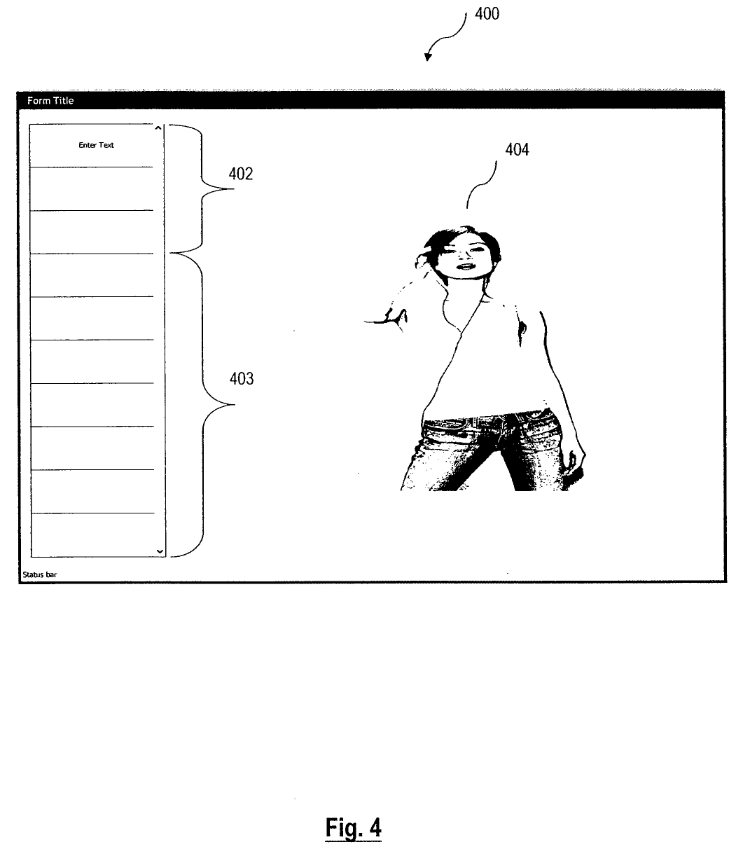

FIG. 4 is a schematic diagram showing an example of an interface 400 displaying the personalized 3-D model according to one embodiment of the present invention. In one implementation, there are numerous rows on the left hand side of the webpage and each is configured to show one item. The items to be purchased in the present transaction as a group 402 could be shown within top rows and the items purchased in the past transactions as another group 403 could be presented below. The consumer might be allowed to move the items to a right hand column where the personalized 3-D model 404 is displayed. As such, the consumer could review the 3-D model 404 with groups of items 402 and/or 403. Alternatively, the 3-D model 404 may display all the items from the groups 402 and 403 for the consumer to review without any maneuvering on the part of the consumer. And thereafter the consumer may remove certain items from the 3-D model 404 in order to see different combinations before deciding which items they really like to purchase.

The above description illustrates various embodiments of the present invention along with examples of how aspects of the present invention may be implemented. One embodiment of the present invention may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive, ROM chips, or any type of solid-state non-volatile semiconductor memory) on which information is permanently stored; and (ii) writable storage media (e.g., floppy disks within a diskette drive, CD-RW disks, DVD-RW disks, flash memory, hard-disk drive, or any type of solid-state random-access semiconductor memory) on which alterable information is stored. The above examples, embodiments, instruction semantics, and drawings should not be deemed to be the only embodiments, and are presented to illustrate the flexibility and advantages of the present invention as defined by the following claims.

1. A method for enhancing consumer on-line shopping experience, comprising:
accessing a consumer profile comprising:
a first consumer information including at least information describing physical attributes of a consumer; and
a purchase history for the consumer;
generating a consumer image based on the first consumer information;
presenting a graphical user interface screen, comprising:
presenting a first set of selectable items according to the first consumer information, the first set of selectable items representing items purchasable during a current shopping session; and
presenting a second set of selectable items corresponding to items purchased by the consumer during a previous shopping session and selected according to the purchase history, wherein the items corresponding to the first and second set of selectable items are adapted to be worn;
receiving a first selection of at least one selectable item included in the first set of selectable items;
receiving a second selection of at least one selectable item included in the second set of selectable items;
generating, by one or more computer processors, a modified form of the image reflecting the first selection and the second selection; and
outputting the modified image.

2.-10. (canceled)

11. A computer-readable storage medium containing a sequence of instructions executable within a computer system having a processing unit, wherein the sequence of instructions, when executed by the processing unit, causes the processing unit to:
access a consumer profile storing:
a first consumer information including at least information describing physical attributes of a consumer; and
a purchase history for the consumer;
generate a consumer image on the basis of the first consumer information;
presenting a graphical user interface screen, comprising:
presenting a first set of selectable items according to the first consumer information, the first set of selectable items representing items purchasable during a current shopping session; and
presenting a second set of selectable items corresponding to items purchased by the consumer during a previous shopping session and selected according to the purchase history, wherein the items corresponding to the first and second set of selectable items are adapted to be worn;
receiving a first selection of at least one selectable item included in the first set of selectable items;
receiving a second selection of at least one selectable item included in the second set of selectable items;
generating, by one or more computer processors, a modified form of the image reflecting the first selection and the second selection; and
outputting the modified image.

12.-20. (canceled)

21. The method of claim 1, wherein the information describing physical attributes of the consumer includes body measurement information provided by the consumer.

22. The method of claim 21, wherein the first set of selectable items are selected for inclusion in the graphical user interface screen on the basis of the body measurement information.

23. The method of claim 1, wherein retrieving the image of the consumer comprises loading a predetermined three-dimensional (3-D) model and adjusting the 3-D model on the basis of the information describing physical attributes of the consumer.

24. The method of claim 23, further comprising:
receiving further selections from a different consumer;
adjusting the predetermined 3-D model on the basis of the further selections and information describing physical attributes of the different consumer.

25. The method of claim 1, wherein the second set of selectable items are retrieved from a purchase history repository for the consumer and visually identified in the graphical user interface screen as being historical purchases.

26. The method of claim 1, further comprising:
receiving a selection to purchase the items corresponding to the received selections.

27. The computer-readable storage medium of claim 11, wherein the information describing physical attributes of the consumer includes body measurement information provided by the consumer.

28. The computer-readable storage medium of claim 27, wherein the first set of selectable items are selected for inclusion in the graphical user interface screen on the basis of the body measurement information.

29. The computer-readable storage medium of claim 11, wherein retrieving the image of the consumer comprises loading a predetermined three- dimensional (3-D) model and adjusting the 3-D model on the basis of the information describing physical attributes of the consumer.

30. The computer-readable storage medium of claim 29, further comprising:
receiving further selections from a different consumer;
adjusting the predetermined 3-D model on the basis of the further selections and information describing physical attributes of the different consumer.

31. The computer-readable storage medium of claim 11, wherein the second set of selectable items are retrieved from a purchase history repository for the consumer and visually identified in the graphical user interface screen as being historical purchases.

32. The computer-readable storage medium of claim 11, further comprising:
receiving a selection to purchase the items corresponding to the received selections.

33. A system, comprising:
one or more computer processors;
a memory containing a program which, when executed by a processor, performs an operation, comprising:
accessing a consumer profile comprising:
a first consumer information including at least information describing physical attributes of a consumer; and
a purchase history for the consumer;
generating a consumer image based on the first consumer information; and
presenting a graphical user interface screen, comprising:
presenting a first set of selectable items according to the first consumer information, the first set of selectable items representing items purchasable during a current shopping session; and
presenting a second set of selectable items corresponding to items purchased by the consumer during a previous shopping session and selected according to the purchase history, wherein the items corresponding to the first and second set of selectable items are adapted to be worn;
receiving a first selection of at least one selectable item included in the first set of selectable items;
receiving a second selection of at least one selectable item included in the second set of selectable items;
generating, by one or more computer processors, a modified form of the image reflecting the first selection and the second selection; and
outputting the modified image.
